(19) United States
(12) Patent Application Publication
(10) Pub. No.: US 2013/0062483 A1
(43) Pub. Date: Mar. 14, 2013

(54) DISPLAY HOLDER FOR VEHICLE WINDSHIELDS

(71) Applicant: Roy Moussaieff, Jamaica, NY (US)

(72) Inventor: Roy Moussaieff, Jamaica, NY (US)

(21) Appl. No.: 13/232,394

(22) Filed: Sep. 14, 2011

(51) Int. Cl. F16B 47/00; E06B 7/28

(52) U.S. Cl. 248/205.5; 248/208

(57) ABSTRACT

The invention is directed toward a display holder for displaying and storing one or more items on the interior side of a vehicle windshield. The display holder includes a walled container with at least an upper opening for placing and removing items and an aperture window for viewing the items.

### CROSS-REFERENCE TO RELATED APPLICATIONS

None.

### FIELD OF THE INVENTION

The invention relates to a display holder attached to the interior of a vehicle windshield that allows placement, display and storage of different shaped and sized items

### BACKGROUND OF THE INVENTION

Vehicle drivers require a convenient and accessible means for storing and displaying a wide variety of printed items such as parking receipts, especially “pay and display” coupons and receipts.

Also, radio frequency identification tags (RFID) are becoming commonplace and often require ready access to be read properly.

The subject device provides a convenient and useful storage and display tool. These improvements will be appreciated by drivers and will work successfully in both private and commercial vehicles.

### SUMMARY OF THE INVENTION

A display holder is affixed to the interior side of a vehicle windshield, the display holder comprises a left side wall and a corresponding right side wall where the left side wall is essentially parallel to the right side wall; a back wall positioned between the left side wall and the right side wall; a front wall which includes a left portion and a corresponding right portion, the left portion being essentially parallel to the right portion; and a bottom wall which connects the front wall to the back wall which creates a container for one or more items to be displayed therein.

The invention further includes a method for using the display holder. This method may include affixing the display holder to the interior side of the windshield. This can include use of a fastener such as an adhesive or hook-and-loop fastener. Secondly, one or more items may be positioned within the display holder, where at least one item is capable of being viewed from (and through) the exterior side of the windshield. When affixed to the windshield, the most-current item may be placed and displayed first through the windshield. As yet a third step, these items may be arranged through use of an aperture or simply removed for accounting purposes or for disposal. These three steps may be repeated to display and organize the various items as needed.

Other objects, features and advantages of the present invention will be apparent when the detailed descriptions of the preferred embodiments of the invention are considered with reference to the accompanying drawings, which should be construed in an illustrative and not limiting sense as follows.

### BRIEF DESCRIPTION OF THE DRAWINGS

FIG. 1 is a front perspective view of one embodiment of the subject apparatus.

FIG. 2 is a rear perspective view of the apparatus shown in FIG. 1.

FIG. 3 is front elevation view of the apparatus shown in FIG. 1.

FIG. 4 is a front elevation view of the subject apparatus mounted on a windshield and including an example parking receipt.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

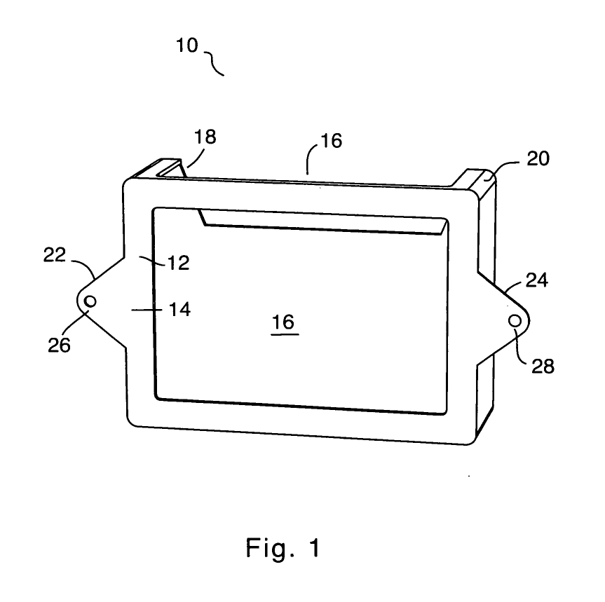

FIG. 1 depicts display holder 10 having front wall 12 having a display window there through defined by opening edge 14, through which rear wall 16 can be seen. The front and rear walls are offset by respective side walls 18 and 20. A bottom wall is not shown. Each side of front wall 12 also has fastener standoffs 22 and 24. In this embodiment, each standoff has a fastener boss 26 and 28 suitable for affixing a suction cup or similar fastener.

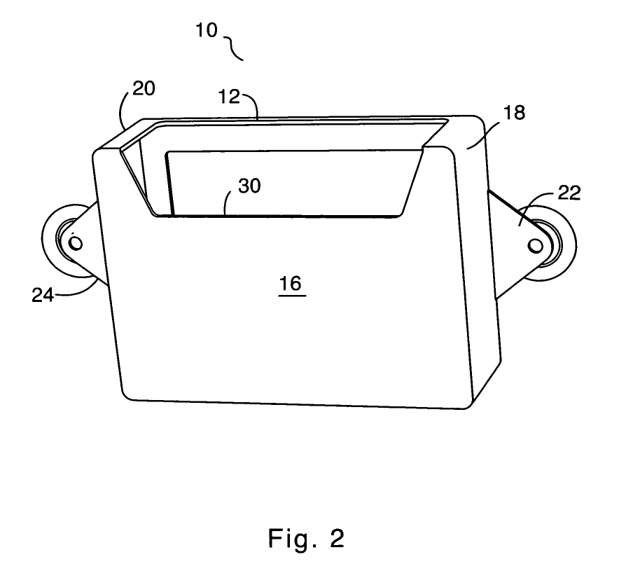

FIG. 2 depicts a rear view of holder 10 seen in FIG. 1 where similarly numbered elements are the same. Also seen in FIG. 2 is cut-out edge 30 in rear wall 16 which facilitates insertion or removal of items from display holder 10. It will be recognized in this embodiment that five separate walls define the enclosure for display holder 10.

Conventional suction cups can be utilized in conjunction with display holder 10 as well as other fasteners such as hook-and-loop fasteners or adhesives such as glue, epoxy or the like.

Moreover, the display holder 10 is preferably manufactured out of a thermoplastic polymer resin or composite capable of being injection molded. It can also be manufactured of suitable paperboard, i.e., capable of maintaining the holder's shape.

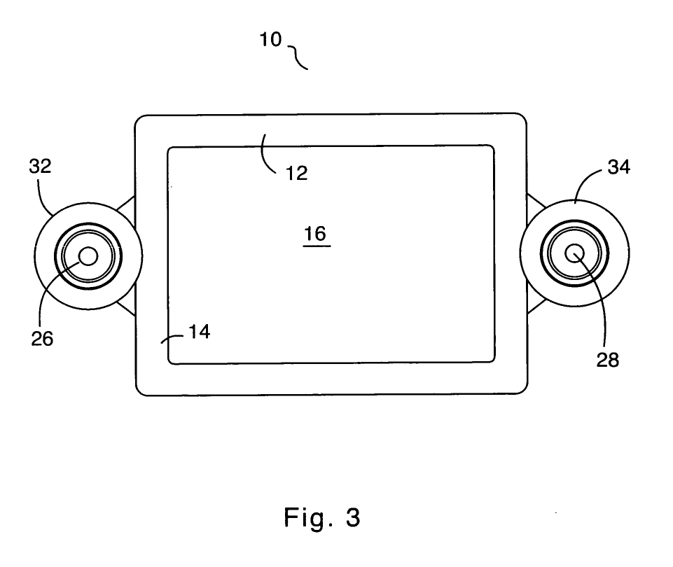

FIG. 3 depicts display holder 10 having rear wall 16 seen through the window defined by edge 14. In this view, fastener bosses 26 and 28 are engaged with flexible suction cups 32 and 34 respectively.

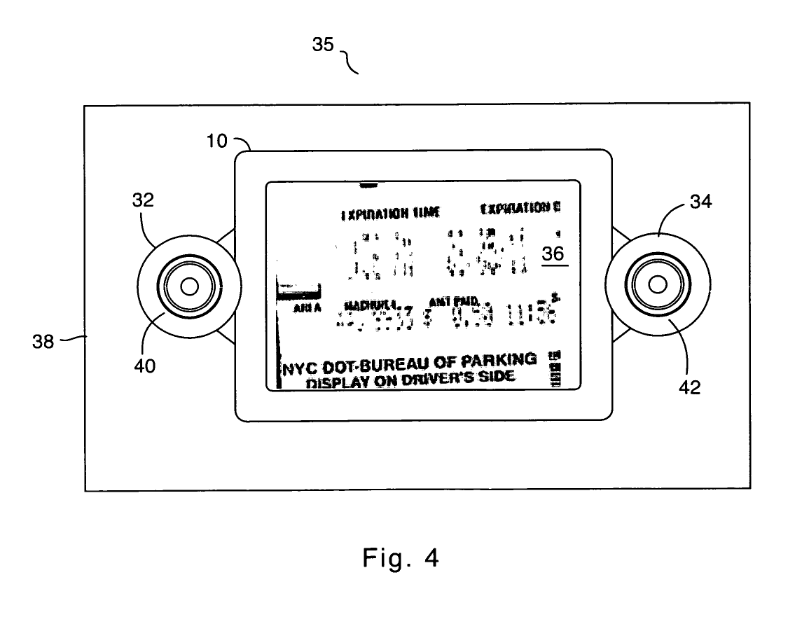

FIG. 4 illustrates how the display holder 10 and a sample parking receipt 36 can be viewed through the exterior side of a vehicle windshield 38. In this figure, suction cups 32 and 34 have been affixed to the interior of windshield 38 via seals 40 and 42.

### EXAMPLE 1

A display holder was injection molded from polyethylene resin and had front and rear walls 2.375 inches high by 3.25 inches wide, opposite side walls 2.375 inches high by 0.375 inches wide and a bottom wall 3.25 inches long by 0.375 inches wide. Each opposite side wall had a fastener standoff having a round fastener boss approximately 0.24 inches high to which was attached a flexible plastic suction cup having a diameter of approximately 0.75 inches. The rear wall of the display holder had a 0.625 inch cutout at its top edge to facilitate insertion and removal of items therein. The front wall hade an opening aperture of approximately 2.75 inches by 2.0 inches. In other embodiments, the aperture opening can be covered with a transparent film window. In operation, the display holder was affixed to the interior surface of a vehicle windshield and proved effective for displaying or storing a plurality of items therein.

The invention now being fully described, it will be apparent to one of ordinary skill in the art that many changes and modifications can be made thereto without departing from the spirit or scope of the invention set forth herein.

1. A display holder for being affixed to the interior side of a vehicle windshield, the display holder comprising: a left side wall and a corresponding right side wall where the left side wall is essentially parallel to the right side wall; a rear wall positioned between the left side wall and the right side wall; a front wall which includes a left portion and a corresponding right portion, the left portion being essentially parallel to the right portion; and a bottom wall which connects the front wall to the back wall which creates a container for one or more items to be displayed therein.

2. A display holder according to claim 1 wherein said front wall has a display window defined therein.

3. A display holder according to claim 1 wherein each side of said front wall include a fastener standoff

4. A display holder according to claim 3 wherein each standoff has a fastener boss for affixing a fastener thereto.

5. A display holder according to claim 4 wherein said fastener is a suction cup.

6. A display holder according to claim 1 wherein said rear wall has a cut out edge for insertion and removal of items from said holder.

7. A display holder according to claim 1 wherein said holder is made of a thermoplastic resin.

8. A display holder according to claim 2 wherein said display window is covered with a transparent film material.

9. A display holder according to claim 2 wherein said rear wall has a cut out edge which facilitates insertion or removal of items from said display holder.

10. A method of using the display holder of claim 1 which comprises affixing the display holder to the interior side of the windshield, positioning one or more items within the display holder wherein at least one item is capable of being viewed from and through the exterior side of the windshield, and arranging or removing the items through the use of an aperture in the rear wall.
